(19) United States
(12) Patent Application Publication
(10) Pub. No.: US 2015/0074015 A1
(43) Pub. Date: Mar. 12, 2015

(54) SYSTEM AND METHOD FOR DISSEMINATING A CERTIFIED ANALYSIS FOR REFERENCE MATERIALS

(71) Applicant: SPEX Certiprep, Metuchen, NJ (US)

(72) Inventors: Neil Stein, Sea Girt, NJ (US); Peter Eskow, Edison, NJ (US)

(73) Assignee: SPEX Certiprep, Metuchen, NJ (US)

(21) Appl. No.: 14/025,270

(22) Filed: Sep. 12, 2013

(51) Int. Cl. G06Q 10/06; G06Q 10/10

(52) U.S. Cl. CPC G06Q 10/0631; G06Q 10/107
USPC 705/343

(57) ABSTRACT

Systems and methods for disseminating information pertaining to a reference material or certified reference material are disclosed. In one embodiment, the system includes the certified reference material and a package containing same, the package comprising a storage medium that stores an information product in a machine-readable format, the information product comprising either a pointer to certified analysis data or the certified analysis data itself. In one embodiment, the method comprises adding a quantity of a certified reference material to a package, incorporating, on the package, a storage medium for storing the information product, and encoding the information product in the storage medium.

### FIELD OF THE INVENTION

The present invention relates to reference materials for use in calibrating analytical instruments.

### BACKGROUND OF THE INVENTION

Analytical instruments, such as inductively coupled plasma spectrometers (“ICP”), ICP-mass spectrometers (“ICP-MS”), gas chromatographs (“GC”), liquid chromatographs (“LC”), mass spectrometers (“MS”), and the like require routine calibration. Calibration is typically performed using a “standard,” such as commercially purchased reference sample (“RM”), or certified reference sample (“CRM”).

The CRM is a sample of one or more compounds, materials, etc., of known weight and chemical analysis. The specifics of the CRM, including its packaging, sample size, and phase (gas, liquid, solid), is a function of the analytical device being calibrated as well as the intended analytical application. CRMs include, for example, organic standards for GC, GC-MS, LC, and LC-MS. CRMs additionally include inorganic standards for calibrating atomic absorption spectrometer (“AA”), ICP, ICP-MS, ion chromatograph (“IC”), ion selective electrode (“ISE”), and X-ray fluorescence-fusion (“XRF-fusion”), among others. A certificate that includes a certified analysis for the each CRM is available from the supplier thereof. CRMs and certificates of analysis are available from SPEXCertiPrep of Metuchen, N J and others.

An analytical instrument is calibrated using a CRM in the following manner. A suitable CRM and corresponding certificate of analysis is obtained from a supplier. An operator keys the analysis information from the certificate into the computer that controls the analytical instrument. The CRM sample is introduced into the instrument requiring the calibration and is analyzed. Calibration software compares the response generated by the not-yet-calibrated instrument against the certified analysis from the certificate, as input by the operator.

To the extent the instrument response and the certified analyses deviate from one another, the instrument is adjusted via an appropriate calibration algorithm, in known fashion. The instrument is thus “calibrated,” at least for compounds found in the CRM.

This calibration process is subject to a variety of sources of human error, a few of which pertain directly to the CRM and its corresponding certificate of analysis. First, simple transcription errors can be made by the individual responsible for inputting the certified analysis. Second, an individual responsible for inputting the certified analysis might use the “nominal” concentration of the sample, rather than the actual concentration. For example, the nominal concentration of a sample might be 100 mg/L, but the actual concentration of the sample, as reported on the certificate of analysis, might be 99.8 mg/L. Depending upon the particular type of analytical method/instrument requiring calibration, this can introduce small systemic errors into a “calibrated” instrument.

### SUMMARY OF THE INVENTION

Embodiments of the invention provide a way to improve the calibration process for an analytical instrument by reducing sources of human error. In accordance with the illustrative embodiment of the invention, packaging for a certified reference material (or a reference material) comprises a storage medium for storing a first information product in machine-readable form. The term “certified reference material” or “CRM” will hereinafter be used to refer to both certified reference materials and reference materials. The first information product is either:
(1) a “pointer” to a location from which the information normally contained in a certificate of analysis (i.e., that provides the precise weight of the CRM and the precise concentration of various analytes therein) can be obtained; or
(2) the analysis itself; that is, the information normally contained in the certificate of analysis.

The first information product, being machine readable, can be, without limitation, in the form of digitized information conveyed acoustically, chemically, electrically, magnetically, mechanically, or optically. It can be in the form of a physical image, wherein in some embodiments, the first information product (i.e., the information content of the first information product) is in a form that is not understandable to an unaided human viewer on inspection of the image. For example, if the first information product is in the form of a bar code (without accompanying alphanumeric characters) or a QR code, a human viewer will not be able to tell what alphanumeric characters are represented by simply viewing these codes; a bar code or QR code reader will be required for that. In some other embodiments, the information conveyed by the first information product is in a form that is understandable to a human viewer on inspection. For example, the first information product can be in the form of written language, such as a pictogram, an ideogram, a string (i.e., an ordered set of symbols, alphanumeric or otherwise). In some embodiments, even if the first information product is understandable to an unaided human viewer, it will be machine readable, such as by optical character recognition (“OCR”), or, if formed of magnetic ink characters, by magnetic ink character recognition (“MICR”). The phrases “[first] information product” and “information content of the [first] information product” are used synonymously herein.

The CRM package can be in the form of a bottle, ampule, vial, dromedary bag or any other vessel/container typically used by suppliers to store and transport reference materials or certified reference materials.

The storage medium can be, without limitation, a physical image (e.g., a bar code, a QR code, written language, etc.), an electronic chip/circuit (e.g., RFID tag, NFC tag, smart card, etc.), an optical storage medium (e.g., hologram, cd, dvd, etc.), or a magnetic storage medium. The storage medium can appear: (i) directly on a surface of the packaging, (ii) on a label/substrate on the surface of the packaging, (iii) be embedded in the packaging.

In some additional embodiments, the first information product is encoded in the CRM itself. In these embodiments, the first information product is obtained or “extracted” by analyzing the CRM via the (un-calibrated) analytical device or some secondary analytical device. For example, in a CRM comprising a protein array or chip, a number of additional unique proteins are added (sufficient to provide about 16-24 bits of information) to the standard proteins. A symbol (e.g., alphanumeric character, etc.) is assigned to each additional protein such that the additional proteins collectively define a string that codes the lot number for the protein array. Thus, to obtain the certified data analysis, the CRM must be analyzed.

In some further embodiments, the first information product is contained in a data storage device that is coupled to the CRM packaging (e.g., such as via a cord, etc.), wherein such devices include, without limitation, an NFC or RFID tag, a USB flash drive, or an SD card.

In still further embodiments, the first information product appears on a sales receipt/invoice/order confirmation for the CRM. In such embodiments, the first information product will typically be in the form of a bar code, a QR code, or written language.

The first information product is initially processed via specialized application software, referred to herein as the “eCert Data Application,” that is installed on (i) the computer that runs the analytical instrument or (ii) an “auxiliary” device, such as a tablet (e.g., iPod Touch®, iPhone® iPad®, Android-based device, or similar device). As discussed further below, the eCert Data Application is capable of performing one or more of the following tasks, in addition to any others:
receiving the first information product;
populating certain fields with the data contained in the information product;
causing the data processing device on which it is installed to connect to the CRM supplier's data processing system;
receiving certified analysis data from the CRM supplier's data processing system using a pointer;
receiving an instrument model from instrument software;
matching information contained in the certified data analysis with the instrument model, thereby generating a second information product; and
transmitting the second information product to the instrument software.

In embodiments in which the eCert Data Application is installed on a computer that runs the analytical instrument, the first information product accompanying the CRM packaging is made available to the eCert Data Application, such as via scanners, readers, input devices, etc., that transmit the first information product to the computer. If the first information product is a pointer (e.g., a lot identifier or the like) to the certified analysis data, then the eCert Data Application causes the computer to connect to the CRM supplier's data processing system (e.g., server(s) and processor-accessible memory) via the Internet, etc., and download the certified analysis. If the first information product is the certified analysis itself, then the retrieval operation from the supplier's data processing system is skipped. Once imported, the eCert Data Application populates appropriate fields with the certified analysis data and performs other processing to prepare a second information product for transmission to the instrument software for calibration of the analytical instrument.

In some cases, the computer that controls the analytical device will not have Internet connectivity. In such embodiments, an auxiliary device that has Internet connectivity, such as smart phone, Wi-Fi-equipped device (such as an iPod Touch®) or tablet, etc., can be used. When used in conjunction with an auxiliary device, the eCert Data Application is typically implemented in two different instantiations. In particular, a modified version of the eCert Data Application that includes some but not all of the functionality of the full Application is installed on the auxiliary device and the full eCert Data Application is installed on the computer that controls the analytical device. For example, in some embodiments, the modified version of the eCert Data Application installed on the auxiliary device is capable of obtaining the certified analysis data but is not capable of performing some of the further processing that is normally implemented via the full eCert Data Application (discussed later in this Specification).

The first information product pertaining to the CRM is made available to auxiliary device by, for example, using (i) the auxiliary device's camera, (ii) peripheral devices that can be physically attached to the auxiliary device, such as bar code scanners, etc., or (iii) devices that “attach” via a computer telecommunications protocol, such as Bluetooth, Wi-Fi, Zigbee, etc., to read, for example, NFC tags or RFID tags. If the first information product is a pointer to the certified analysis, the modified eCert Data Application causes the auxiliary device to wirelessly connect to the CRM supplier's data processing system via the Internet, etc., and obtain the certified analysis data. If the first information product is the certified analysis itself, then the retrieval operation from the manufacturer's data processing system is skipped. In either scenario, the auxiliary device obtains the certified analysis data and then transmits it to the computer that controls the analytical instrument.

In some embodiments, the invention provides a system for disseminating a first information product pertaining to a certified reference material, wherein the system includes the certified reference material and a package that contains the certified reference material, wherein the package comprises a storage medium for storing a first information product in a machine-readable format, wherein the first information product comprises at least one of: (a) a pointer for accessing certified analysis data, in a machine-readable format, pertaining to the certified reference material; or (b) the certified analysis data.

In some additional embodiments, the invention provides a system for disseminating a first information product pertaining to a certified reference material, wherein the system includes the elements disclosed in the preceding paragraph as well as a data processing system, wherein the certified analysis data is stored in a memory accessible to the data processing system and is accessed via the pointer.

In further embodiments, the invention provides a method comprising the tasks of adding a quantity of a certified reference material to a package, incorporating, on the package, a storage medium for storing an information product in a machine-readable format; and encoding the first information product in the storage medium, wherein the first information product comprises at least one of: (a) a pointer for accessing certified analysis data, in a machine-readable format, pertaining to the certified reference material; or (b) the certified analysis data.

In another embodiment, the invention provides a method that includes the tasks disclosed in the preceding paragraph as well as the tasks of receiving, at a data processing system, a request from a requestor to transmit certified analysis data corresponding to the certified reference material; and transmitting the certified analysis data to the requestor.

In yet a further embodiment, the invention provides a computer-readable non-transitory medium containing program instructions for obtaining, organizing, and transmitting certified analysis data for calibrating an analytical instrument, wherein execution of the program instructions by one or more processors of a computer system causes the one or more processor to carry out the tasks of:
(a) receiving, from instrument software that controls the analytical device, information pertaining to an instrument method, wherein the information comprises a first set of analytes, wherein, when the analytical instrument analyzes a sample presented thereto, it analyzes for the presence of the analytes in the first set thereof;
(b) receiving a first information product stored, in machine-readable format, in a storage medium on a package for the reference sample, wherein the first information product relates to certified analysis data that comprises the amounts of analytes in a reference sample;
(c) generating a second information product by matching the amounts of analytes in the certified analysis data with like analytes in the first set thereof; and
(d) transmitting the second information product to the instrument software for use in calibrating the analytical instrument.

Additional embodiments of the invention are disclosed in the Detailed Description section of this Specification.

### BRIEF DESCRIPTION OF THE DRAWINGS

FIG. 1A depicts system 100A for implementing embodiments of the invention.

FIG. 1B depicts the contents of processor-accessible memory in the computer that controls the analytical instrument.

FIG. 1C depicts a flow diagram of method 100C in accordance with some embodiments of the invention.

FIGS. 2A-2D depict methods for obtaining a machine-readable version of certified analysis data in accordance with present teachings.

FIGS. 3A-3C depict three embodiments of CRM packaging in accordance with embodiments of the invention, wherein CRM packaging comprises machine-readable information encoded in various formats.

FIGS. 4A-4B depict two additional embodiments of CRM packaging in accordance with embodiments of the invention, wherein the packaging includes a label comprising a data storage device that includes machine-readable information.

FIGS. 4C-4D depict an embodiment of CRM packaging in accordance with a further embodiment of the invention, wherein the packaging comprises smart-card technology.

FIG. 4E depicts an embodiment wherein a data storage device is coupled to CRM packaging in accordance with an embodiment of the invention.

FIG. 5 depicts tasks for implementing task 101 of method 100C of FIG. 1C in accordance with some embodiments of the invention.

FIG. 6 depicts task 602 for implementing task 502 of FIG. 5 in accordance with some embodiments of the invention.

FIG. 7 depicts method 700 for implementing task 602 of FIG. 6 in accordance with some embodiments of the invention.

FIG. 8 identifies three methods 802A, 802B, and 802C for implementing task 504 of FIG. 5.

FIG. 9 depicts a flow chart of method 802A for implementing task 504 of FIG. 5.

FIG. 10 depicts a flow chart of tasks for implementing task 103 of method 1008.

FIG. 11 depicts tasks for implementing task 107 of method 100C.

FIG. 12 depicts a flow diagram of method 1200 in accordance with the illustrative embodiment of the present invention.

FIG. 13 depicts a first illustrative page of an exemplary graphical user interface (“GUI”) of the eCert Data Application.

FIG. 14 depicts a second illustrative page of an exemplary GUI of the eCert Data Application.

FIG. 15 depicts an illustrate page of an exemplary GUI of instrument software for controlling an analytical instrument.

### DETAILED DESCRIPTION

Definitions. The terms appearing below and any inflected forms thereof, are provided with the follow explicit definitions for use in this description and the appended claims.
“CRM” is an acronym meaning “certified reference material.” A CRM is a reference material that is characterized by a metrologically valid procedure for determining one or more specified properties, accompanied by a certificate that provides the value(s) of the specified property, its associated uncertainty, and a statement of metrological traceability. As used herein, reference herein to a “CRM” or “certified reference material” is to be understood to refer also to a “reference material” (though a CRM and an RM are considered to be different in the art). A “reference material” is defined as a material that is sufficiently homogeneous and stable with respect to one or more specified properties, which has been established to be fit for its intended use in a measurement process. http://www.comar.bam.de/en/
“Certified Analysis Data” means at least some of the information contained in the certificate of analysis that is available for each CRM. As used herein, “certified analysis data” also refers to at least some of the information contained in a certificate that accompanies an RM.
“Encode” means presenting the information contained in the first information product in a format suitable for the particular storage medium that is used to convey the first information product. The encoded information may be, but is not necessarily, encrypted. The term “encode” does not require, but will often entail, formatting the information in such a way that it is not readily understandable by (although visible to) a human observer, such as if presented as a bar code or a QR code. In such embodiments, the first information product must be “read” or “decoded” by a suitable device, such as a bar code reader, etc. In some cases, the information will not even be visible to a human observer, such as when it is stored in a memory stick, an RFID tag, or the like. In some alternative embodiments, the first information product can be in the form of a string of symbols, such as alphanumeric characters, that represents a lot number of a CRM. In such embodiments, the information conveyed by the first information product is not hidden or obscured to a human viewer. In this example, the storage medium is the ink that appears on the package and the encoding of the information is the formation of the alphanumeric characters that represent the lot number.
“Extract”, as used in the context of retrieving the first information product from the storage medium on the CRM packaging, means reading, scanning, etc., the information that is encoded or otherwise stored in or on the storage medium such that it can be transmitted processor-accessible storage within, for example, the computer that controls an analytical device.
“Machine-readable” means information that can be read by a device/machine, such as a computer, bar code scanner, optical character reader, Webcam, smart card reader, etc.
“Machine-readable information” means any format or form of energy that is able to encode/retrieve information is a form of “machine-readable information.”
“Pointer” identifies a location wherein desired information—the certified analysis data—is stored. In the context of this invention, examples of a pointer include, without limitation, a CRM lot number or a memory storage address.
“Transmit” means actual or logical transmission of, for example, information and/or data. As an example of the actual transmission, the information content of the first information product is actually transmitted from a storage medium on CRM packaging to a data processing system. As an example of the latter, a first software program that generates a second information product might store the data corresponding to the second information product in storage registers that are then accessed by a second software program. The second information product can be said to be logically transmitted from the first software program to the second software program.
“Written Language” includes, without limitation, a pictogram, an ideogram, or a string (i.e., an ordered set of symbols, alphanumeric or otherwise).
   Additional definitions, which will be identified in bold font, may be provided throughout the Specification.

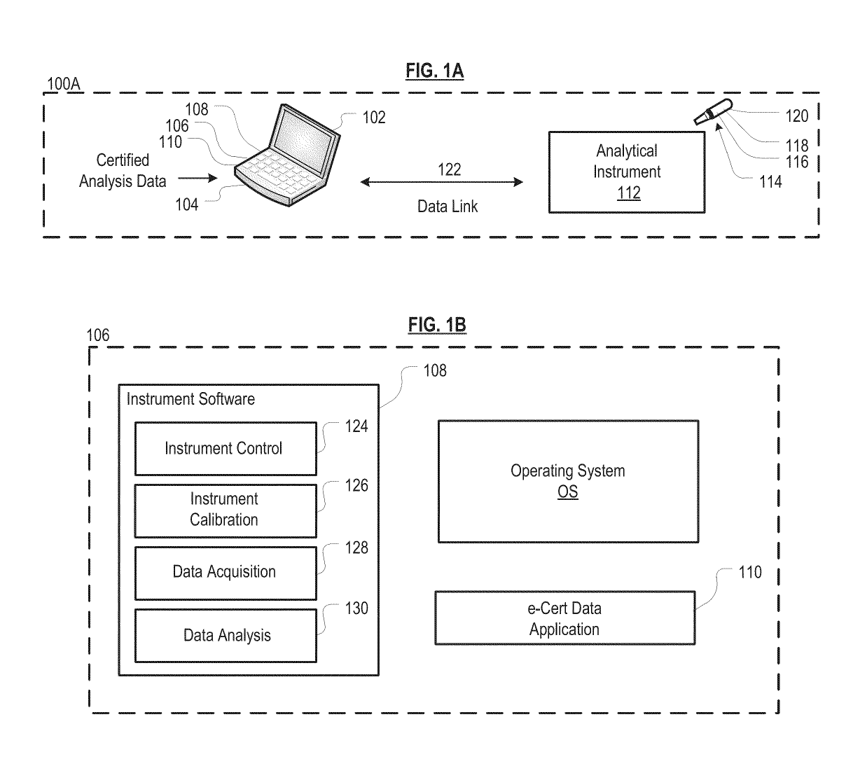

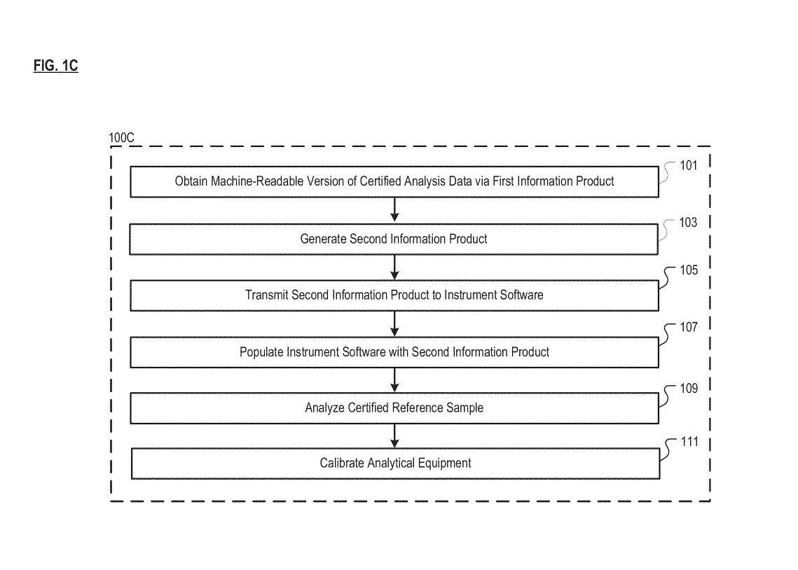

FIG. 1A depicts system 100A for implementing the illustrative and alternative embodiments of the invention.

System 100A includes computer 102, analytical instrument 112, and CRM packaging 114 containing CRM 116, interrelated as shown.

Computer 102 is a general purpose computer, and includes processor 104 and processor-accessible storage 106. Processor 104 is capable of, among other tasks, running the operating system of computer 102, executing specialized application software (discussed further below), and populating, updating, using, and managing data in processor-accessible storage 106.

FIG. 1B depicts some of the contents of processor-accessible storage 106. Processor-accessible storage 106 is a non-volatile, non-transitory memory technology (e.g., hard drive(s), flash drive(s), etc.) that, in the illustrative embodiment, stores Operating System OS and specialized application software, including Instrument Software 108 and e-Cert Data Application 110. It will be clear to those skilled in the art how to make and use alternative embodiments that comprise more than one memory, or comprise subdivided segments of memory, or comprise a plurality of memory technologies that collectively store Operating System OS and the specialized application software.

Instrument software 106 is typically provided by the manufacturer of analytical instrument 112. The instrument software provides standardized or custom platforms for controlling analytical equipment 112. The functionality of instrument software 106 includes, without limitation, instrument control 124, instrument calibration 126, data acquisition 128, and data analysis 130. The nature and operation of the instrument software is well known to those skilled in the art.

The e-Cert Data Application 110, which is unique to embodiments of the present invention, is discussed extensively below and throughout this Specification.

With continued reference to FIG. 1A, computer 102 and analytical instrument 112 communicate via a computer telecommunications protocol over data link 114, which can be wired or wireless.

Analytical instrument 112 can be any of a wide variety of instruments suitable for the analysis and characterization of inorganic and organic compounds, as known in the art. For example, and without limitation, analytical instrument 112 can include a gas chromatograph, a gas chromatograph-mass spectrometer, a liquid chromatograph, liquid chromatograph-mass spectrometer, atomic absorption spectrometer, inductively coupled plasma spectrometer, inductively coupled plasma-mass spectrometer, ion chromatograph, and X-ray fluorescence.

CRM 116 is used to calibrate analytical instrument 112. Knowing that uncharacterized samples that are to be analyzed by instrument 112 will likely contain a set of specific analytes, but not knowing which analytes or the amounts thereofs in the samples, an instrument operator will obtain from a supplier an appropriate CRM for the calibration process. An “appropriate” CRM is one that includes many of the analytes that are expected to be present in the as-yet uncharacterized samples. More than one CRM may be required to calibrate the instrument in preparation for analyzing a given sample.

In accordance with the illustrative embodiment, CRM packaging 114 comprises storage medium 118 comprising a first information product 120. As discussed further below, first information product 120 is either a “pointer” to a machine readable version of the certified analysis data corresponding to the selected CRM, or it is a machine readable version of the certified analysis itself. In the illustrative embodiment, the pointer is a CRM lot number.

In some embodiments in which information product 120 is a pointer, the certified analysis data corresponding to the selected CRM is stored in memory locations that are accessible by the CRM supplier's data processing system. In some alternative embodiments, first information product 120 is encoded in the CRM itself. In yet some further embodiments, first information product 120 is stored in a device that is coupled (a memory stick, etc.) to CRM packaging 114 or is otherwise associated (an invoice, sales receipt, etc.) with the CRM.

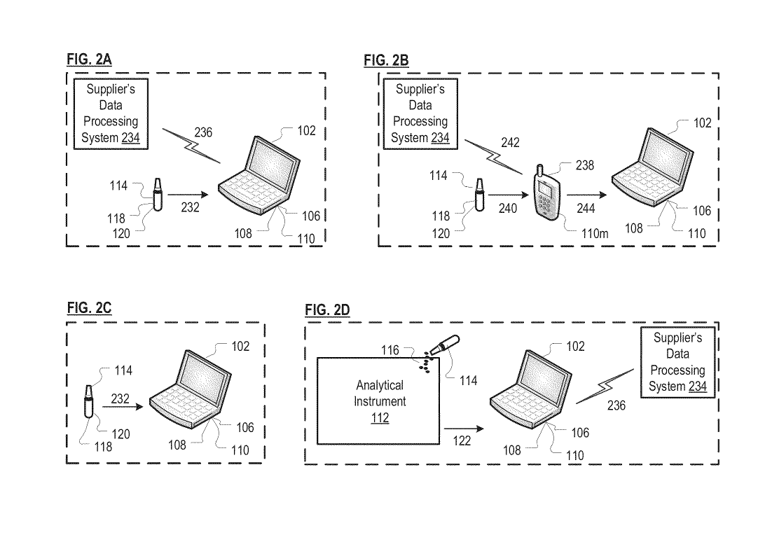

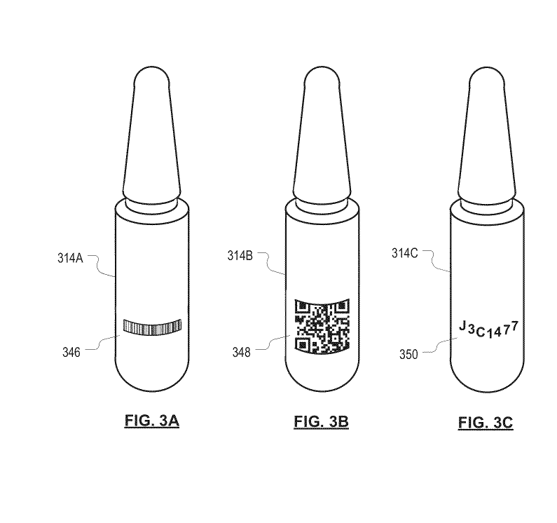

FIG. 1C depicts a flow diagram of method 100C for calibrating analytical equipment in accordance with an embodiment of the invention. With reference to both FIGS. 1A and 1C, and in accordance with task 101 of method 100C, a machine-readable version of certified analysis data is obtained via a first information product. Ways for accomplishing this are discussed in conjunction with FIGS. 2A through 2D and elsewhere in the Specification.

The certified analysis data is “automatically” entered into eCert Data Application 110 that is installed on computer 102 in accordance with the illustrative embodiment. This enables an operator to avoid having to manually enter (e.g., via typing, etc.) the values that appear in a conventional certificate of analysis that is available for each CRM. Although, in some embodiments, an operator manually enters the “pointer” (e.g., lot number of the CRM, etc.) into the device that will access the certified analysis data (for “automatic” entry into the eCert Data Application). In some alternative embodiments, the eCert Data Application (or a modified version thereof) is installed on an auxiliary device, such as when computer 102 lacks connectivity to CRM supplier's data processing system.

Either before or after the certified analysis data is accessed by eCert Data Application 110, information pertaining to a selected “instrument method” by which the analytical instrument performs its analysis is also accessed by the eCert Data Application. The selected instrument method, with is normally one of a number of instruments methods available for selection, is part of the Instrument Software 108. Among other information, the instrument method will provide a list of analytes, and the wavelengths, masses, delay times, etc., at which the instrument will check for such analytes when it analyzes a sample.

In task 103, eCert Data Application “matches-up” the amounts of analytes from the certified data analysis with the list of analytes provided in the selected instrument method, thereby generating a second information product. The second information product, which includes the certified analysis data, is transmitted to instrument software 108 and populates same, per tasks 105 and 107.

In accordance with task 109, CRM 116 is analyzed by analytical instrument 112. There will be a deviation between the response of the uncalibrated instrument (i.e., the calculated concentration of each analyte in CRM 116) and the certified values for the concentration of those analytes in CRM 116. Instrument software 108 uses this information, in conjunction with calibration data, in ways known to those skilled in the art (instrument calibration functionality 126) to calibrate analytical instrument 112, per task 111. The analytical instrument can then be used to analyze uncharacterized samples.

A key aspect of embodiments presented herein pertains to task 101—obtaining a machine-readable version of certified analysis data via the first information product. FIGS. 2A through 2D depict several ways to obtain such information.

FIG. 2A depicts an embodiment wherein first information product 120 encoded/stored in storage medium 118 on package 114 is a pointer to a location wherein the certified analysis data is stored. The first information product is “extracted” and imported into computer 102 under the control of eCert Data Application 110 installed in processor-accessible memory 106 of computer 102. Arrow 216 signifies importation of the first information product into the computer via a format-appropriate methodology/device (e.g., keyboard input, bar code reader, optical scanner, etc.). The eCert Data Application 110 then accesses CRM supplier's data processing system 234 over telecommunications link 232 (e.g., the Internet, etc.) to download the certified analysis data corresponding to the pointer. Alternatively, the pointer can be used to trigger supplier's data processing system 234 to send an e-mail to computer 102, wherein a file containing the certified analysis is attached to the email. The is preferably in a format that can be imported into the computer for use via e-Cert Data Application 110, such as an Excel file, .csv (comma separated values), a custom XML file, etc. The eCert Data Application then populates appropriate fields with the downloaded certified analysis data for eventually exporting same to instrument software 108.

FIG. 2B depicts an embodiment wherein computer 102 does not have Internet connectivity and first information product 120, which is encoded/stored in storage medium 118 on package 114, is a pointer to a location wherein the certified analysis data is stored. In this embodiment, a modified eCert Data Application 110m, which typically includes some but not all of the functionality of the eCert Data Application, is installed on auxiliary device 238 (e.g., a smart phone, etc.). For example, modified eCert Data Application 110m, at a minimum, includes the ability to:
access the first information product that is captured by auxiliary device 238;
direct auxiliary device 238 to connect to the CRM supplier's data processing system;
access the certified analysis data from the CRM supplier's data processing system;
download the certified analysis data to auxiliary device 238; and
populate appropriate fields with the certified analysis data.
   Arrow 240 signifies importation of first information product 120 into auxiliary device 238 via a format-appropriate methodology/device (e.g., keyboard input, camera, bar code reader, optical scanner, etc.).

With continued referenced to FIG. 2B, modified eCert Data Application 110m on auxiliary device 238 accesses CRM supplier's data processing system 234 over telecommunications link 242 (e.g., the Internet, etc.) to download the certified analysis data corresponding to the first information product (pointer). The modified eCert Data Application then populates appropriate fields with the downloaded certified analysis data. Modified eCert Data Application 110m transmits the certified analysis data, via data link 244, to computer 102. An instance of eCert Data Application 110 running on computer 102 populates appropriate fields with the certified analysis data for eventually transmission to the instrument software 108.

FIG. 2C depicts an embodiment wherein first information product 120, which is encoded/stored in storage medium 118 on package 114, is the certified analysis data itself. The first information product is “read” and transmitted to computer 102 under the control of eCert Data Application 110. Arrow 232 signifies importation of the first information product into the computer via a format-appropriate methodology/device (e.g., camera, bar code reader, optical scanner, etc). The eCert Data Application then populates appropriate fields with the downloaded certified analysis data for eventually transmitting same to the instrument software 108.

FIG. 2D depicts an embodiment wherein first information product 120, rather than being stored in a storage medium on package 114, is encoded in the CRM itself. The CRM is analyzed by (uncalibrated) analytical instrument 112. Since the first information product is encoded by the presence of a particular analytes (such as a unique grouping of proteins), rather than the precise concentration of the analytes, an uncalibrated instrument will be suitable for accomplishing this function. For such an embodiment, only a “pointer” is encoded (encoding the full certified analysis data for the CRM requires more bits of information than could practically be provided via this approach). The analysis performed by analytical instrument 112 is transmitted, over data link 122, to computer 102. The eCert Data Application 110 in processor-accessible memory 106 installed on computer 102 receives the analysis and “decodes” the pointer based on the identified proteins. The eCert Data Application 110 then accesses CRM supplier's data processing system 218 over telecommunications link 236 (e.g., the Internet, etc.) to download the certified analysis data corresponding to the pointer. The eCert Data Application 110 then populates appropriate fields with the downloaded certified analysis data for eventually transmitting same to the instrument software 108.

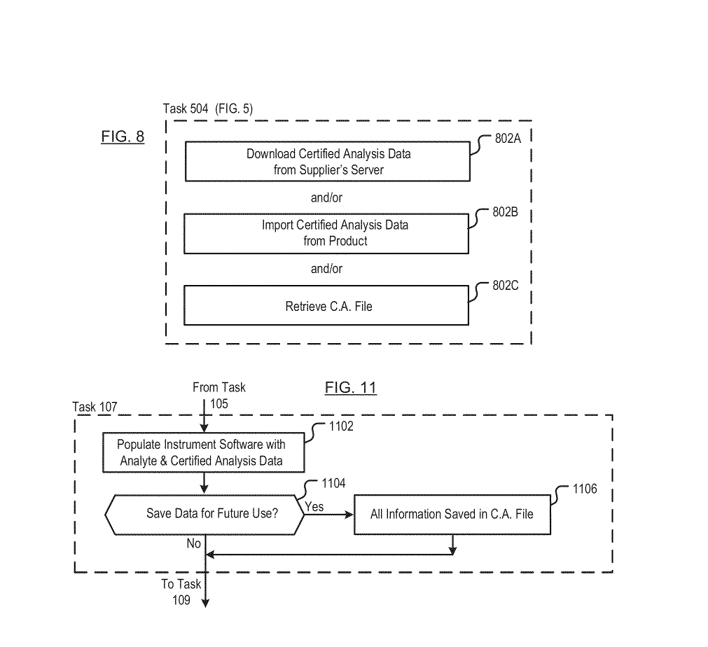

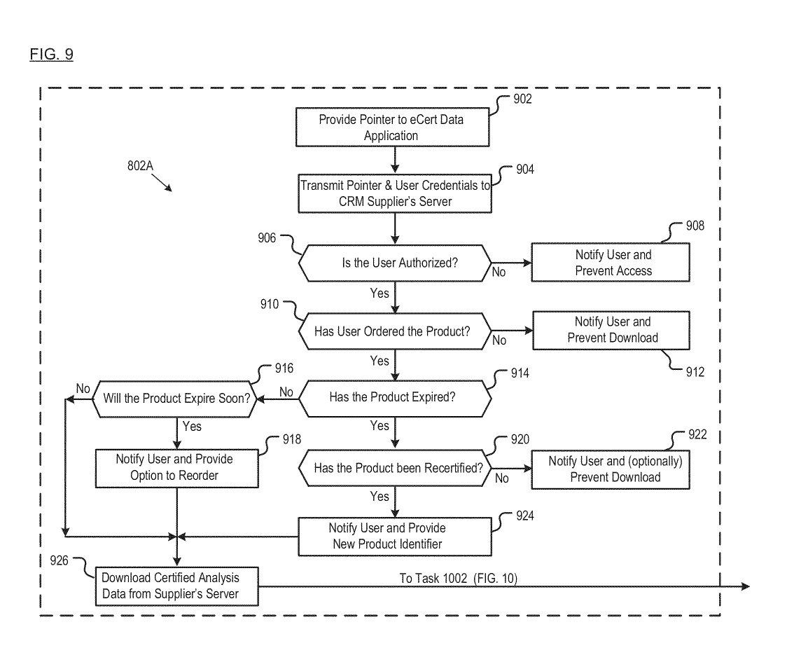

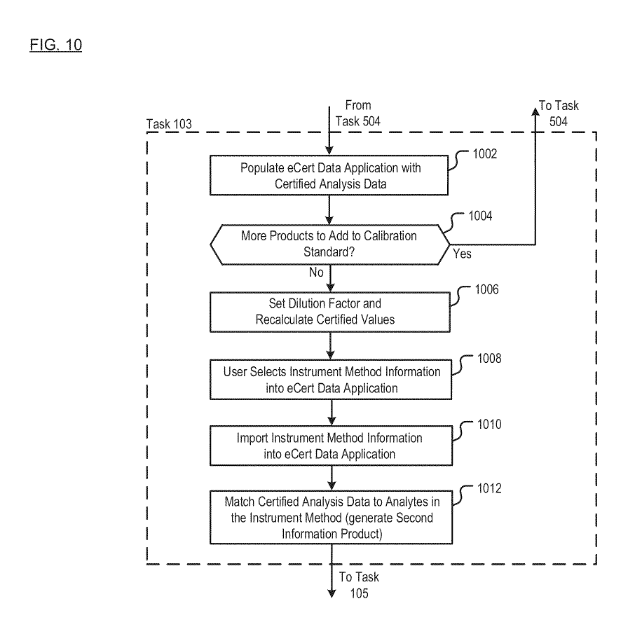

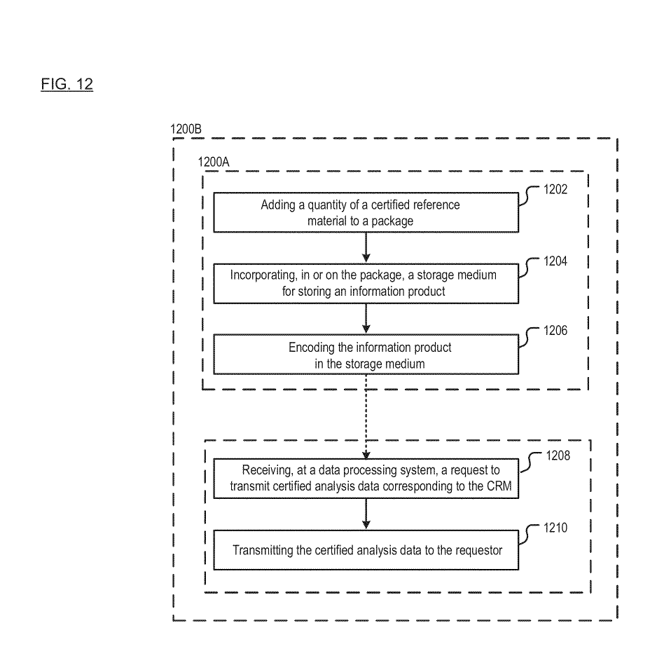

Additional description of the manner in which a machine-readable version of the certified analysis data is obtained provided later in this Specification (see, e.g., FIGS. 8 and 9 and the accompanying description).

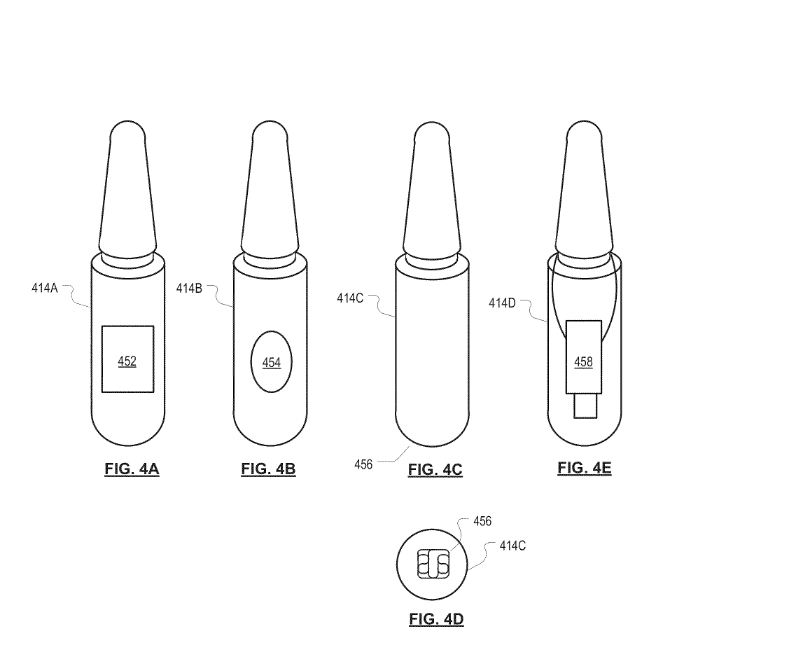

FIGS. 3A-3C depicts embodiments of CRM packages, wherein the packages comprises a first information product encoded in various storage media. In FIGS. 3A through 3C, the CRM packaging is implemented as an ampule and the storage media appears directly on its surface.

In CRM package 314A depicted in FIG. 3A, the storage medium is bar code 346 and the first information product is encoded in the bar code (e.g., the width of the bars, etc.). Although not depicted in FIG. 3A, it is often the case that the string encoded by the bar code appears beneath the bar code. In FIG. 3B, which depicts CRM package 314B, the storage medium is QR code 348 and the first information product is encoded in the QR code (e.g., the pattern of dots, e.g.). CRM package 314C of FIG. 3C includes a storage medium configured as string 350 and the first information product is encoded by the symbols in the string. In the embodiments depicted in FIGS. 3A-3C, the format of the storage media is not appropriate for storing the amount of information necessary to encode certified analysis data for a typical CRM. As a consequence, in these embodiments of a CRM package, the first information product is a pointer to the location of the certified analysis data.

FIGS. 4A-4E depict further embodiments of CRM packages in accordance with the present teachings, wherein the storage media are electronic storage devices that contain the first information product. In FIGS. 4A through 4E, the CRM package is again implemented as an ampule.

In FIG. 4A, CRM package 414A comprises a storage medium configured as RFID tag 452. In FIG. 4B, CRM package 414B comprises storage medium configured as NFC tag 454. The tags store the first information product. In these embodiments, the tags are in the form of labels that can be adhered directly to the surface of ampule.

FIGS. 4C-4D depict CRM package 414C, wherein the storage medium is implemented as smart-card 456 or a similar technology platform. The storage medium is embedded in the surface of package 414C. The smart card stores the first information product. In preferred embodiments, smart card 456 is configured for capacitive or inductive interrogation via a smart card reader. In less preferred embodiments, smart card 456 is configured for electrical interrogation via a smart card reader.

FIG. 4E depicts CRM Package 414E, wherein the storage medium is memory stick 458, which is coupled to package 414E, such as by a cord. The first information product is stored on the memory stick.

In the embodiments depicted in FIGS. 4A-4E, the format of the storage media is capable of storing a large amount of information. As such, in these embodiments, the machine-readable information can include, as an alternative to a pointer to the certified analysis data, the certified analysis data itself.

Of course, when shipped, the CRM packages depicted in FIGS. 3A through 3C and FIGS. 4A through 4C and 4E will contain a certified reference material.

A format-appropriate peripheral device is used to “extract” first information product from the CRM packages. For example, a bar code reader, a QR code reader, and optical character reader are used, respectively, to obtain the first information product from respective bar code 346, QR code 348, and string 350. Likewise, an RFID reader is used to capture the first information product from RFID tag 452, an NFC reader is used to obtain the first information product from NFC tag 454, and a smart-card reader is used to obtain the first information product from smart card 456. Unless otherwise integrated into computer 102 or auxiliary device 238, these peripheral devices communicate over a wired or wireless data link to the computer or auxiliary device to provide the first information product thereto.

Although FIGS. 3A-3C and 4A-4E depicts embodiments of CRM packages wherein the package is an ampule, it is to be understood that, in other embodiments consistent with the present teachings, the CRM package can be a bottle, a vial, a dromedary bag, or any other type of packaging in which a CRM is typically provided.

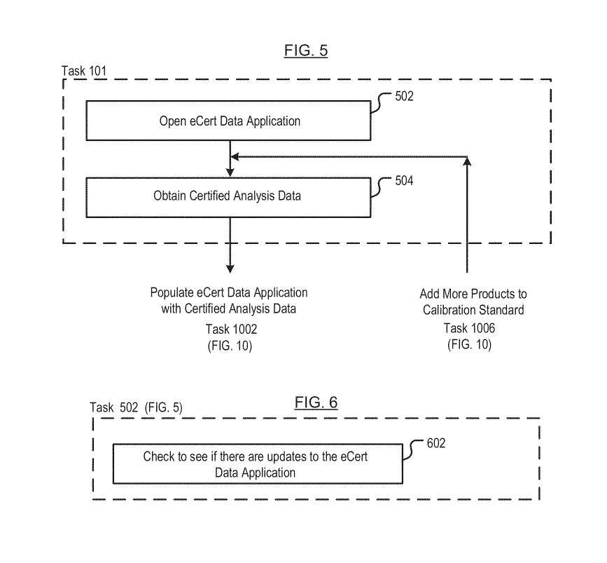

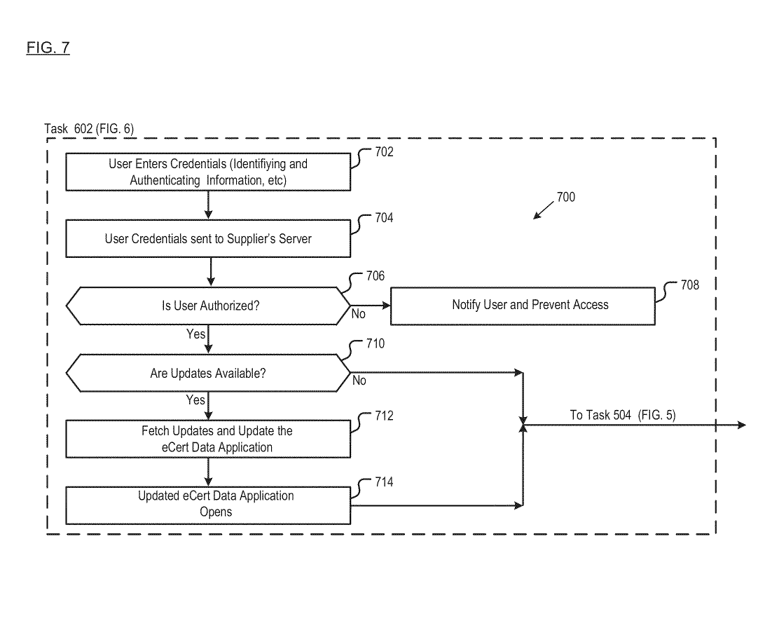

FIGS. 5 through 11 depict flow charts for performing the methods disclosed herein. It is to be understood that the order of the various tasks shown in the flow charts is illustrative; that is, unless clearly prohibited by the nature of the tasks, the order of the tasks is freely permutable.

FIG. 5 depicts a flow chart for implementing task 101—obtaining machine-readable version of certified analysis data via the first information product—of method 100C (FIG. 1C).

Per task 502, the eCert Data Application is opened by a user. The eCert Data Application (or a modified version thereof) resides on computer 102 or auxiliary device 238 (FIG. 2B). The discussion of task 502 continues in conjunction with FIGS. 6 and 7.

Referring now to FIG. 6, task 502 includes (sub)task 602, which recites determining if any updates are available for the eCert Data Application. FIG. 7 depicts a flow chart of method 700 for implementing task 502 and (sub)task 602 on a device (e.g., computer 102, auxiliary device 238, etc.) having connectivity to the CRM supplier's data processing system.

Per optional task 702 of method 700, a user enters credentials, such as a user name, password, and any other identifying, authenticating, of personal information required for access to the supplier's data processing system. The user's credentials are transmitted to the supplier's data processing system at task 704. The data processing system determines whether the user is authorized per query 706. If the user is not authorized, the user is so notified at task 708. If the user is authorized, at query 710, inquire whether updates to the eCert Data Application are available. If not, processing advances to task 504 of FIG. 5 (discussed further below). If updates are available, the updated eCert Data Application is fetched per task 712 and is opened at task 714. Processing then advances to task 504 of FIG. 5.

Referring again to FIG. 5, after completing task 502, such as via method 700, the certified analysis data is obtained per task 504.

FIG. 8 identifies three methods 802A, 802B, and 802C for obtaining the certified analysis data. Method 802A is used to obtain the requisite data by downloading it from the CRM supplier's data processing system (such as when a pointer to the location of the information is available). Method 802B is used when the certified analysis data can be obtained directly from the CRM packaging. And method 802C is used if the certified analysis data has been previously stored in a Certified Analysis (“C.A.”) file.

FIG. 9 depicts a flow chart for method 802A (downloading the certified analysis data from the CRM supplier's data processing system). In accordance with task 902, a pointer, such a product lot number, etc., is provided to the eCert Data Application. This task involves extracting the pointer (i.e., first information product) from:
(i) the CRM packaging (see FIGS. 2A, 2B, 3A-3C and 4A-4D and the accompanying description); or
(ii) a storage device coupled to or otherwise accompanying the CRM packaging (see FIG. 4E); or
(iii) an invoice/sales receipt/confirmation pertaining to the CRM; or
(iv) the CRM itself (see FIG. 2D, pointer encoded in the CRM).
   As previously discussed, computer 102 or auxiliary device 238 obtains the pointer (first information product) using a format-appropriate methodology/device; that is, a bar code reader, optical scanner, RFID tag reader, etc.

Per task 904, the eCert Data Application causes computer 102 or auxiliary device 238 to transmit the pointer and user credentials to the CRM supplier's data processing system. The data processing system determines, at query 906, whether the user is authorized to access the data processing system. If not, then access is prevented and the user is notified at task 908. If user credentials were previously supplied during the user's current interaction with the data processing system (see, e.g., tasks 702 through 708 of method 700 at FIG. 7), then query 906 and task 908 are bypassed and only the pointer is transmitted at task 904.

The CRM supplier might not want to provide a user with access to certified analysis data for a CRM that the user has not ordered. To that end, method 802A includes query 910, wherein the data processing system determines from supplier records whether the user has in fact ordered the CRM that is the subject of the user's inquiry. If not, download of the certified analysis data is prevented and the user is so notified per task 912.

If the user has ordered the corresponding CRM, the data processing system determines at query 914 whether the CRM has expired. Each CRM will have an expiration date, which is necessitated due to potential degradation of the included analytes or permeation thereof through the packaging.

If the CRM has expired, the data processing system determines whether it is has been recertified, per query 920. If the CRM has not been recertified, the user is notified at task 922 and, optionally, download of the certified analysis data is prevented. If the CRM has been recertified then, at task 924, the user is notified and a new identifier for that CRM lot, as appropriate, is provided to the user. Recertification is based on follow-up testing that shows that the original certified analysis for the CRM is still valid.

If, at task 914, the data processing system determines that the CRM has not expired, query 916 determines whether the CRM is to expire within a timeframe that is considered by the supplier to be “impending” or “soon” (e.g., within 1 month, etc.). If expiration is determined to be impending, then the user is notified and provided with an option to re-order the CRM per task 918.

Following a negative determination at query 916, or following tasks 918 or 924, the certified analysis data is downloaded to the computer/auxiliary device according to task 926.

Returning to FIG. 8, a second way to obtain the certified analysis data is via method 802B. This method is used when the certified analysis data (i.e., first information product) can be obtained directly from the CRM packaging or via a storage device that is coupled to or otherwise accompanies the packaging.

Method 802B is analogous to task 902 of method 802A. That is, the method involves extracting the certified analysis data from:
(i) the CRM packaging (see FIGS. 2C and 4A-4D and the accompanying description); or
(ii) a storage device coupled to or otherwise accompanies the CRM packaging (see FIG. 4E).
   As previously discussed, computer 102 or auxiliary device 238 obtains the certified analysis data using a format-appropriate methodology/device; that is, a bar code reader, optical scanner, RFID tag reader, etc.

The third method disclosed for obtaining the certified analysis data is to retrieve a C.A. (certified analysis) file. This method is applicable in situations in which a user has previously obtained the certified analysis data (either via method 802A or 802B) and, during the course of processing (as discussed later in conjunction with FIG. 11), has saved the data in the aforementioned C.A. file. Method 802C will be discussed further in conjunction with the discussion of FIG. 11.

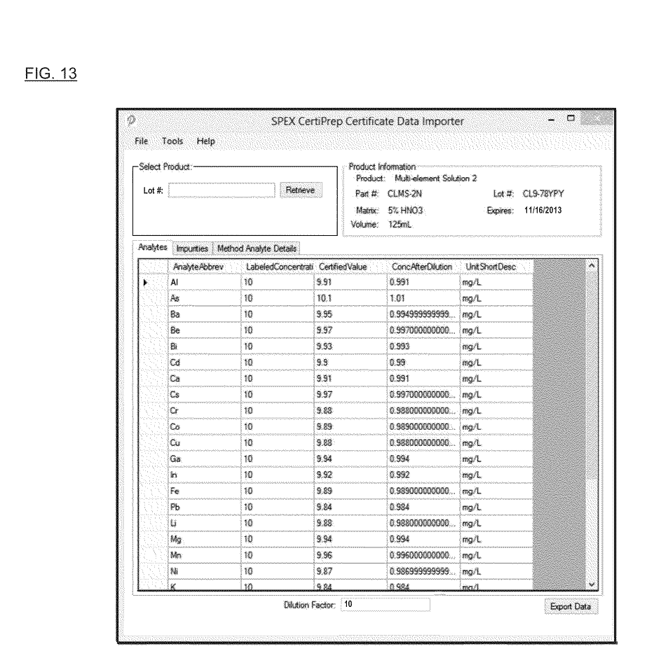

Thus, method 802A (see, FIG. 9 at task 926), method 802B, or method 802C can be used, as appropriate, to implement task 504 of FIG. 5. With the completion of tasks 502 and 504, the processing required for task 101 of method 100C (FIG. 1C) is essentially complete (unless the analysis for an additional CRM is required, as discussed further below). FIG. 10 depicts a method to implement task 103 (i.e., Generate second information product) of method 100C.

With reference to task 1002 of FIG. 10, appropriate fields within the eCert Data Application (or modified eCert Data Application when processing on auxiliary device 238) are populated with the “first” certified analysis data.

The user is queried by the eCert Data Application at 1004 as to whether certified analysis data corresponding to an additional CRM is to be required. Such additional information will be necessary, for example, when the instrument “method” that is selected (see task 1008) requires certified data for analytes that are not present in the first CRM. If such additional information is required, then processing returns to task 504 of the method depicted in FIG. 5 (which is implemented via methods 802A (FIG. 9), 802B, or 802C for another CRM).

If the user responds in the negative to query 1004, then at task 1006, the user select a dilution factor, if appropriate, and the eCert Data Application adjusts the certified analysis data to account for the specified dilution. Such dilution might be necessary, for example, if the concentration of the analytes in the CRM is too high for the analytical device being used or the expected range of the unknown sample that will be analyzed.

At task 1008, the user selects an instrument method, which is then imported at task 1010 from the instrument software into the eCert Data Application. The instrument method, which is familiar to those skilled in the art, will provide a listing of analytes and, for example, one or more wavelengths, masses, delay times, etc., at which the instrument will check for such analytes.

Per task 1012, the certified analysis data is matched up with the analytes listed in the instrument method (see FIG. 13), thereby generating the second information product. The second information product is then transmitted to the instrument software according to task 105 of method 1006.

With reference now to FIG. 11, which depicts (sub)tasks for accomplishing task 107, the instrument software is populated, per task 1102, with the second information product, as transmitted at task 105. The user is queried, at 1104, whether the data that populates the instrument software per task 1102 should be saved for future use. If the user answers affirmatively, the data is saved in a C.A. File, as per task 1106. The C.A. File was previously referenced in conjunction with method 802C as one of the three ways to obtain the certified analysis data.

After saving the data in the C.A. File, or choosing not to save it, the CRM is analyzed by analytical instrument 112 at task 109 of method 100C. Those skilled in the art will know how to use any of a variety of analytical instruments to analyze the CRM.

The response of analytical instrument 112 is reported to the instrument software. This information, and well as the certified analysis data, is used at task 111 to calibrate analytical instrument 112 via instrument calibration functionality 126 of instrument software 108. The selection of appropriate calibration curves, and the application of the certified analysis data and instrument response thereto, is within the capabilities of those skilled in the art.

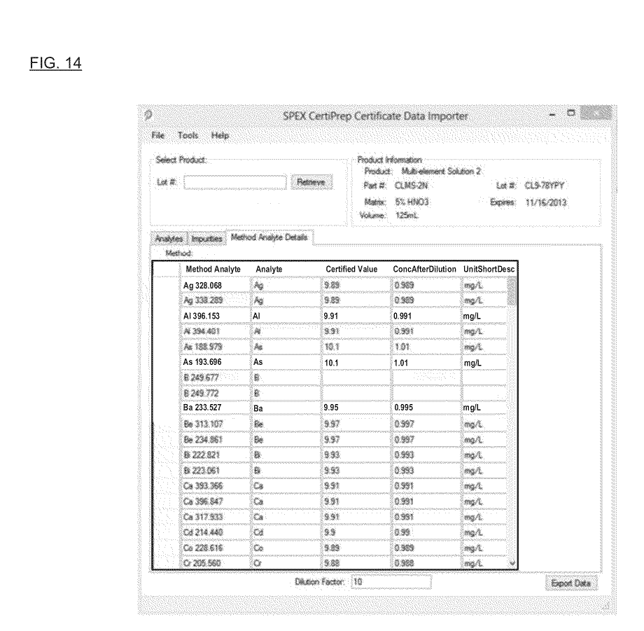

FIG. 12 depicts methods 1200A and 1200B in accordance with the illustrative embodiment of the present invention. Method 1200A recites tasks 1202 through 1206 and method 1200B includes tasks 1202 through 1210.

Task 1202 recites adding a quantity of a certified reference material to a package. This task is performed by the CRM supplier, typically after the certified analysis has been performed. Per task 1204, a storage medium for storing the first information product that is to accompany the CRM is incorporated in the package that is to contain the CRM. The first information product is stored/encoded in the storage medium, per task 1206.

It is important to note that, depending on the nature of the storage medium, the encoding of the first information product can occur simultaneously with the creation of the storage medium and, in some case, with its incorporation in/on the package. For example, the lines comprising a bar code encode the first information product. So, the storage medium is formed and the first information product is encoded simultaneously. In embodiments in which the bar code appears directly on a surface of the CRM package, the incorporation of the storage medium (bar code) on the package occurs simultaneously with the creation of the storage medium and with the encoding of the first information product. Thus, depending on the nature of the storage medium and the manner in which it is incorporated in the CRM package, tasks 1204 and 1206 can occur simultaneously.

Method 1200A is thus directed to CRM packaging and, more generally, to a method for disseminating information pertaining to a certified reference material. Method 1200B extends method 1200A, reciting tasks 1208 and 1210. Per task 1208, receiving, at the CRM supplier's data processing system, a request to transmit certified analysis data corresponding to the CRM to a requestor thereof. At task 1210, the requested information is transmitted to the requestor.

In the methods described thus far, a first information product is extracted from a storage medium that, in most embodiments, is coupled to the CRM packaging. The first information product is a pointer to the certified analysis data or the certified analysis data itself. If the first information product is a pointer, the pointer is then used to obtain the certified analysis data, such as by triggering a download or email from the CRM supplier's data processing system. In some additional embodiments, a purchaser of a CRM contacts (e.g., via phone, e-mail, etc.) the CRM supplier after ordering a CRM and requests that the certified analysis data be forwarded to the purchaser, such as via e-mail. In some further embodiments, a purchaser can visit the website of the CRM supplier to request and download the certified analysis data. Additionally, in some embodiments, the purchaser can obtain the certified analysis data from a “cloud”-based file repository, such as DropBox™, Microsoft SkyDrive, etc. Also, in some embodiments, when a user places an order for a CRM, certified analysis data is automatically transmitted to the purchaser via a cloud-based file repository. In all such embodiments, the file comprising the certified analysis data is in machine-readable format (e.g., such as an Excel file, .csv, a custom XML file, etc.) for importation into the e-Cert Data Application.

FIGS. 13 and 14 depict pages from an illustrative graphical user interface of an embodiment of the e-Cert Data Application. FIG. 13 depicts the CRM page, which displays information about the CRM including: the name of the CRM (“multi-element Solution 2”), a lot number (“CL9-78YPY”), the matrix in which the analytes in the solution are contained (“5% HNO₃”), the volume of the CRM (“125 mL”), and the expiration date of the CRM (“Nov. 16, 2013). The CRM page also enables a user to enter a lot number for the CRM. Entering a lot number (or other “pointer”) in this fashion enables the eCert Data Application to retrieve the certified analysis data from the CRM supplier's data processing system and is a further way to obtain a machine-readable version of that information in accordance with the present teachings.

The CRM page also depicts the various analytes in the CRM, the nominal concentration of each analyte, the certified value (i.e., the certified analysis data), and the concentration after dilution. The latter value is calculated by applying the user-entered dilution factor (“10” in this example) to the certified values.

FIG. 14 depicts the instrument method page, wherein the analytes that are measured as part of the selected instrument method and the wavelengths at which the instrument will check for those analytes are listed. The certified analysis data for the CRM is matched up to the analytes that are being measured, creating the second information product. To the extent that the CRM does not include some of the listed analytes, and additional CRM is used that includes those missing analytes. For example, in this example, the analyte “B” (boron) is absent from the CRM. Note also that the selected instrument method checks for many of the analytes, “Ag” (silver) among others, at two different wavelengths. The same calibration standard is used for both wavelengths.

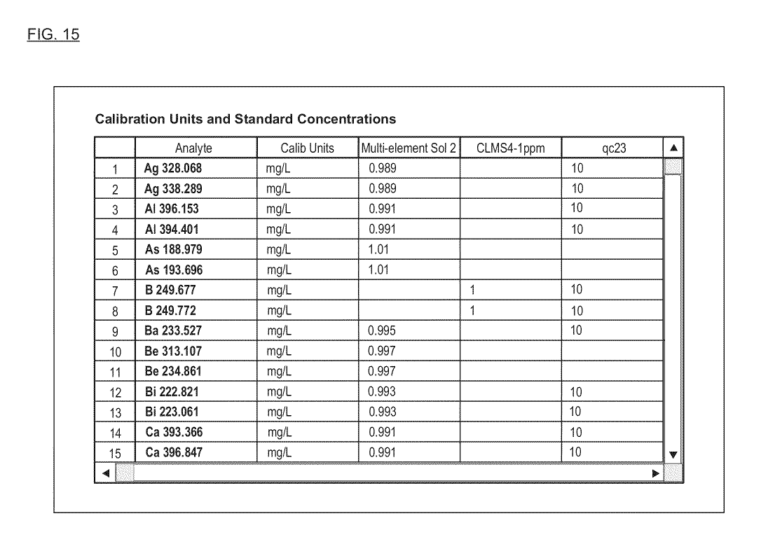

FIG. 15 depicts a page from the graphical user interface of an exemplary instrument software. The particular page shown is the calibration standard/wavelength screen. The information appearing in this page is the second information product that was transmitted from the eCert Data Application. The analytes and wavelengths corresponding to the selected instrument method appear in the second column. In the fourth column, the certified analysis data for the CRM identified as “Multi-element Sol 2” appears, as diluted, and is matched up to the analytes that are being measured. In this example, the Multi-element Sol 2 does not include boron (“B”), and, as such, a second CRM identified as “CLMS4-1ppm,” which contains boron, is used.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A system for disseminating information pertaining to a reference material or certified reference material (hereinafter collectively “CRM”), the system comprising:
(i) the CRM; and
(ii) a package for containing the CRM, wherein the package comprises a storage medium for storing a first information product, wherein the first information product comprises at least one of:
(a) a pointer for accessing certified analysis data, in a machine-readable format, pertaining to the CRM; or
(b) the certified analysis data in a machine-readable format.

2. The system of claim 1 and further comprising a data processing system, wherein the certified analysis data is stored in a memory accessible to the data processing system and is accessed via the pointer.

3. The system of claim 1 wherein the storage medium is a physical image, and wherein the physical image is disposed on at least one of:
(a) a surface of the package; or
(b) a label that adheres to the surface of the package.

4. The system of claim 3 wherein the physical image is selected from the group consisting of a bar code and a QR code.

5. The system of claim 3 wherein at least a portion of the physical image encodes the first information product, and wherein the first information product is not understandable to an unaided human viewer.

6. The system of claim 1 wherein the storage medium is a string that is disposed on at least one of:
(a) a surface of the package; or
(b) a label that adheres to the surface of the package.

7. The system of claim 1 wherein the storage medium comprises an electronic chip.

8. The system of claim 1 wherein the storage medium is selected from the group consisting of an RFID tag, an NFC tag, and smart card.

9. The system of claim 1 wherein the storage medium comprises an optical storage medium.

10. The system of claim 1 wherein the optical storage medium comprises a hologram.

11. The system of claim 1 wherein the storage medium comprises a magnetic storage medium.

12. A method for disseminating information pertaining to a reference material or certified reference material (hereinafter collectively “CRM”), wherein the method comprises:
adding a quantity of a CRM to a package;
incorporating, on the package, a storage medium for storing a first information product; and
encoding the first information product in the storage medium, wherein the first information product comprises at least one of:
(a) a pointer for accessing certified analysis data, in a machine-readable format, pertaining to the CRM; or
(b) the certified analysis data in a machine-readable format.

13. The method of claim 12 wherein the task of incorporating further comprises disposing a physical image on at least one of:
(a) a surface of the package; or
(b) a label that adheres to the surface of the package,
wherein at least a portion of the physical image encodes the first information product and wherein the encoded first information product is not understandable to an unaided human viewer.

14. The method of claim 12 wherein the task of encoding further comprises storing the first information product in a memory location of an electronic device selected from the group consisting of an RFID tag, an NFC tag, and a smart card.

15. The method of claim 12 further comprising:
receiving, at a data processing system, a request from a requestor to transmit certified analysis data corresponding to the CRM; and
transmitting the certified analysis data to the requestor.

16. The method of claim 15 wherein the request comprises the first information product.

17. The method of claim 15 and further comprising determining, in the data processing system, whether the requestor is an authorized user of the data processing system before transmitting the certified analysis data.

18. The method of claim 15 and further comprising determining, in the data processing system, prior to transmitting the certified analysis data, at least one of:
(a) whether the CRM has expired; and
(b) whether the CRM has been recertified.

19. The method of claim 18 and further wherein if the product has expired and the product has not been recertified, then not transmitting the certified analysis data.

20. The method of claim 15 and further comprising determining, in the data processing system, whether the requestor has ordered the CRM before transmitting the certified analysis data.

21. The method of claim 15 and further comprising determining, in the data processing system, if expiration of the CRM is impending, and, if so, notifying the requestor of impending expiration.

22. A computer-readable non-transitory medium containing program instructions for obtaining, organizing, and transmitting certified analysis data for calibrating an analytical instrument, wherein execution of the program instructions by one or more processors of a computer system causes the one or more processor to carry out the tasks of:
(a) receiving, from instrument software that controls the analytical device, information pertaining to an instrument method, wherein the formation comprises a first set of analytes, wherein, when the analytical instrument analyzes a sample presented thereto, it analyzes for the presence of the analytes in the first set thereof;
(b) receiving a first information product, wherein the first information product relates to certified analysis data that comprises the amounts of analytes in a certified reference sample;
(c) generating a second information product by matching the amounts of analytes in the certified analysis data with like analytes in the first set thereof; and
(d) transmitting the second information product to the instrument software for use in calibrating the analytical instrument.

23. The computer-readable non-transitory medium containing program instructions of claim 22 and further wherein in task (b), the first information product is stored in a storage medium on a package for the certified reference sample.

24. A method comprising:
(a) receiving, in non-transitory processor-accessible storage of a data processing system, a first information product, wherein the first information product relates to certified analysis data that comprises amounts of analytes in a certified reference sample;
(b) generating, in the data processing system, a second information product by matching the amounts of analytes in the certified analysis data to analytes of an instrument method for use in analyzing the certified reference sample; and
(c) transmitting, in the data processing system, the second information product to instrument software for use in calibrating the analytical instrument.

25. The method of claim 24 wherein the task of receiving further comprises extracting the first information product from a storage medium on a package for the certified reference sample.

26. The method of claim 25 wherein the first information product comprises a pointer.

27. The method of claim 26 further comprising obtaining the certified analysis data using the pointer.

28. The method of claim 24 wherein task of receiving further comprises receiving a file containing the certified analysis data.
